(19) United States
(12) Patent Application Publication
(10) Pub. No.: US 2020/0278644 A1
(43) Pub. Date: Sep. 3, 2020

(54) HOROLOGICAL GEARING

(71) Applicant: ROLEX SA, Geneva (CH)

(72) Inventor: Raoul Behrend, Nyon (CH)

(73) Assignee: ROLEX SA, Geneva (CH)

(21) Appl. No.: 16/803,725

(22) Filed: Feb. 27, 2020

(30) Foreign Application Priority Data
Mar. 1, 2019 (EP) 19160248.1

(51) Int. Cl. G04B 13/02; G04B 35/00

(52) U.S. Cl. CPC G04B 13/027; G04B 35/00

(57) ABSTRACT

A gearing (E1) for a horological mechanism (100), comprising a first toothed wheel (R1) including first symmetrical teeth (d1) and a second toothed wheel (R2) including second symmetrical teeth (d2), each of the first and second teeth being conformed so that the primitive backlash (J) of the gearing is less than 0.3 .m, or even less than 0.25 .m, or even less than 0.2 .m, or even less than 0.15 .m, or even less than 0.1 .m, or even less than 0.08 .m for the nominal axial center distance (e) of the gearing, where m is the modulus of the wheel of which the tooth forms part.

This application claims priority of European patent application No. EP19160248.1 filed Mar. 1, 2019, the content of which is hereby incorporated by reference herein in its entirety.

The invention concerns a horological gearing. The invention also concerns a horological mechanism comprising a horological gearing of this kind. The invention also concerns a horological movement comprising a horological gearing of this kind. The invention further concerns a timepiece comprising a horological gearing of this kind. The invention finally concerns a method of manufacturing a horological gearing of this kind.

In horology, it is known to determine the profile of the teeth of the wheels and of the pinions on the basis of geometric curves such as the cycloid, the epicycloid, the hypocycloid or the involute of a circle. The wheels and the pinions obtained in this way are defined so as to transmit a rotation speed that remains substantially constant during a tooth drive. Tooth profiles having the property of transmitting a substantially constant torque during a tooth drive are also known.

Conventional toothing profiles are therefore defined so as to address speed and/or torque objectives. In gearing known from the prior art this results in greater or lesser angular backlash as a function of the axial center distance of the toothed wheels. In the particular case of a wheel kinematically linked to a geartrain of a basic movement (in parallel coupling), which is designed to cause to be displayed, for example, information derived from the time, such backlash may induce risks of shaking of the member displaying the information derived from the time, namely jerky and irregular movement of the member for displaying the information derived from the time.

Solutions known from the prior art propose adding friction in a kinematic chain in parallel coupling with the geartrain of the basic movement, so as to generate a resistive torque against the member for displaying the information derived from the time. Solutions of this kind, disclosed for example by the patent applications CH506824 and EP0482443, are however not the optimum in that they may in particular generate a reduction or variation of the amplitude of the oscillations of the balance wheel and therefore degraded chronometric performance. This solution also increases the energy consumption of the movement.

Patent application EP2453321 discloses a specific toothing profile having the property of transmitting a substantially constant torque during a tooth drive. A profile of this kind does not enable as great minimization as possible of the angular backlash during a tooth drive of a gearing of this kind.

Patent application EP1555584 concerns a backlash-compensation toothed mobile the teeth of which are equipped with at least one elastic element. Although a component of this kind advantageously can be substituted for the friction spring, it nevertheless remains fragile compared to a wheel with rigid teeth. Moreover, the angular backlash is minimized, or even canceled out, by the effect of the compression of the teeth, this compression being able to vary according to the axial center distance variations and thereby affecting the energy consumption of the movement of which said mobile is part. A solution of this kind can therefore be improved on.

Patent application EP2053474 concerns a chronograph architecture that has the particular feature of integrating a vertical clutch mobile in the geartrain itself of the basic movement. Thus it is mounted in series between the driving member and the regulating organ of the basic movement, and not in parallel coupling. As a result, the chronograph seconds hand is no longer subjected to random angular movements, independently of any friction spring. An architecture of this kind nevertheless remains highly specific, and requires at least one additional mobile in the geartrain of the basic movement, with the risk of degrading its overall efficiency.

Patent application WO2017157764 aims to alleviate the problem of shaking of a display member by way of the gearing in which the teeth of the wheels have the particular feature of having a modulus less than 0.05 mm. This document does not describe any specific profile defined with the objective of minimizing the angular backlash and/or minimizing variation of the angular backlash as a function of the axial center distance. Moreover, such wheels are not very robust and a priori cannot be produced using conventional manufacturing means.

The object of the invention is to provide a horological gearing enabling improvement of the horological gearings known from the prior art. In particular, the invention proposes a horological gearing enabling limitation of the gearing backlash, in particular limitation of the sensitivity of the backlash to the gearing axial center distance variations.

A horological gearing according to the invention is defined by the following points 1 and 16.

1. A gearing for a horological mechanism, comprising a first toothed wheel including first symmetrical teeth and a second toothed wheel including second symmetrical teeth, each of the first and second teeth being conformed so that the primitive backlash ( [symbol] ) of the gearing is less than 0.3.m, or even less than 0.25.m, or even less than 0.2.m, or even less than 0.15.m, or even less than 0.1.m, or even less than 0.08.m for the nominal axial center distance (e) of the gearing, where m is the modulus of the wheel of which the tooth forms part.

16. The gearing obtained by means of the method as defined in either one of the following points 14 or 15.

Different embodiments of the gearing are defined by the following points 2 to 10.

2. The gearing as defined in point 1, wherein each of the first teeth and of the second teeth is conformed such that the ratio of the variation of maximum angular backlash (jmax) to the variation of the gearing axial center distance (e) is less than 6°/mm or less than 5°/mm or less than 4°/mm or less than 3°/mm for a gearing axial center distance value varying between the nominal gearing axial center distance minus 0.04 mm and the nominal gearing axial center distance plus 0.04 mm.

3. The gearing as defined in point 1 or 2, wherein each of the first and second teeth comprises a profile in a plane perpendicular to an axis of the toothed wheel of which the tooth forms part, the profile comprising a functional portion having the shape of a first circular arc, the first circular arc being defined by:

a radius (rᵤ), and

a center of coordinates (xᵤ,yᵤ) in a direct orthonormal Cartesian system of axes (O₁,\vec{e}ₓ,\vec{e}_{y}; 0₂,\vec{e}ₓ,\vec{e}_{y}) centered on the axis of the toothed wheel of which the tooth forms part, \vec{e}ₓ being a unit vector colinear with an axis of symmetry of the tooth, with:

$${r}_{u} = {p}_{i 1} \frac{2 π {R}_{p}}{z} ,$$

xᵤ=pᵢ₂rᵤ+Rₚ, yᵤ=−pᵢ₃ rᵤ z: the number of teeth on the wheel of which the tooth forms part; Rₚ, the primitive radius of the wheel R1 or R2 concerned; pᵢ₁,pᵢ₂,pᵢ₃: parameters determined so that the primitive backlash ( [symbol] ) of the gearing is less than 0.3.m, or even less than 0.25.m, or even less than 0.2.m, or even less than 0.15.m, or even less than 0.1.m, or even less than 0.08.m for the nominal axial center distance (e) of the gearing, when m is the modulus of the wheel on which the tooth forms part.

4. The gearing as defined in one of the preceding points, wherein the profile comprises a tooth head portion having the shape of a second circular arc, the second circular arc being in particular defined by a particular radius (rₜ) as follows:

rₜpᵢ₄(rᵤ+yᵤ)

with: pᵢ₄: a parameter determined so that the primitive backlash ( [symbol] ) of the gearing is less than 0.3 .m, or even less than 0.25.m, or even less than 0.2.m, or even less than 0.15.m, or even less than 0.1.m, or even less than 0.08.m for the nominal axial center distance (e) of the gearing, when m is the modulus of the wheel on which the tooth forms part.

5. The gearing as defined in any one of the preceding points, wherein the parameters (pᵢ₁) pᵢ₂, pᵢ₃, pᵢ₄) constitute the coordinates of a first vector (\vec{p}) satisfying the following condition:

(\vec{p}-\vec{p}*)ₜ H (\vec{p}-\vec{p}*) ≤1 with: H: a covariance type matrix, and \vec{p}*: a vector with coordinates (p₁*,p₂*,p₃*,p₄*).

6. The gearing as defined in any one of the preceding points, wherein:

the gearing ratio is equal to 1 and/or the first and second wheels have the same number of teeth, and

the teeth of the first and second wheels have the same geometry, or wherein:

the gearing ratio is equal to 1 and/or the first and second wheels have the same number of teeth, and

the teeth of the first and second wheels have different geometries.

7. The gearing as defined in any one of the preceding points, wherein the first wheel and/or the second wheel is or are secured to a display member and/or wherein the first wheel and/or the second wheel is or are intended to form part of a geartrain of a horological movement, and in particular is intended to be interleaved, directly or indirectly, between a driving member and a member adjusting a horological movement, and/or wherein the first wheel and/or the second wheel is or are intended to be mounted in parallel coupling with a geartrain of a horological movement.

8. The gearing as defined in any one of points 1 to 7, wherein the first and second wheels are rigid.

9. The gearing as defined in any one of points 1 to 7, wherein at least one of the first and second wheels comprises an elastic angular-backlash-compensation structure, in particular an elastic structure consisting of at least one cut-out in a wheel.

10. The gearing as defined in the preceding point, wherein the angular-backlash-compensation elastic structure is not loaded at the nominal axial center distance.

A horological mechanism according to the invention is defined by the following point 11.

11. A horological mechanism, in particular a horological mechanism for displaying time information or information derived from time or not time related, comprising a gearing as defined in any one of the preceding points.

A horological movement according to the invention is defined by the following point 12.

12. A horological movement comprising a gearing as defined in any one of points 1 to 10 and/or a horological mechanism as defined in the preceding point.

A timepiece according to the invention is defined by the following point 13.

13. A timepiece comprising a gearing as defined in any one of points 1 to 10 and/or a horological mechanism as defined in point 11 and/or a horological movement as defined in point 12.

A method according to the invention of producing a gearing is defined by the following point 14.

14. A method of manufacturing a gearing as defined in any one of points 1 to 10 and/or a horological mechanism as defined in point 11 and/or a horological movement as defined in point 12 and/or a timepiece as defined in point 13, wherein it comprises:

a step of determination of the profiles of the first and second toothings of the first wheel and of the second wheel,

a step of shaping the first and second wheels,

a step of mounting the first and second toothed wheels so that they mesh with one another.

One embodiment of the method of manufacture is defined by the following point 15.

15. The method as defined in the preceding point, wherein the determining the profiles of the first and second toothings of the first wheel and of the second wheel comprises, after a step of selection, in particular a step of arbitrary selection, of profiles of the first and second toothings, iteration of the following steps:

determination of the performance of the profiles of the toothings;

generation of new toothing profiles using genetic algorithms, in particular stochastic optimization algorithms based on mechanisms of natural selection and of genetics and/or algorithms employing evolutionary operators, namely selection and/or crossing and/or mutation.

The appended figures represent, by way of example, three embodiments of a timepiece according to the invention.

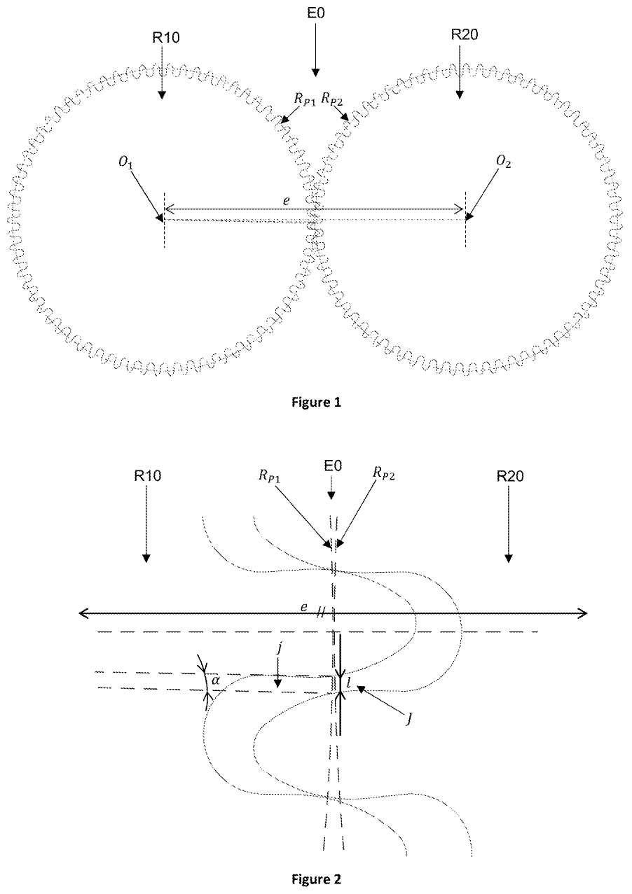

FIGS. 1 and 2 show a gearing known from the prior art.

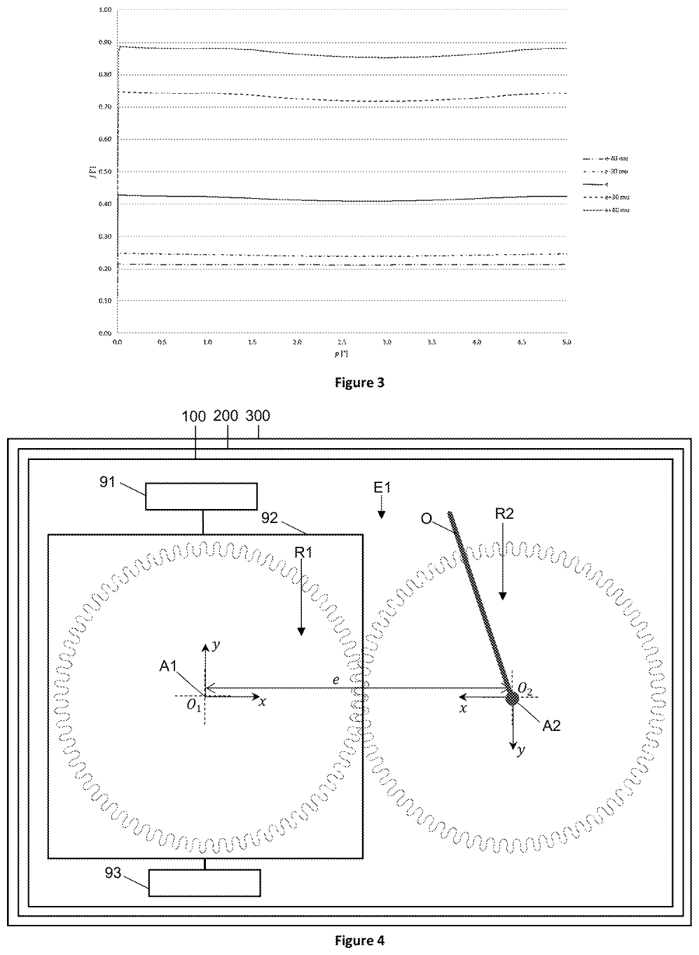

FIG. 3 is a graph representing the angular backlash variations of the gearing from FIGS. 1 and 2 over one step and for different axial center distance values.

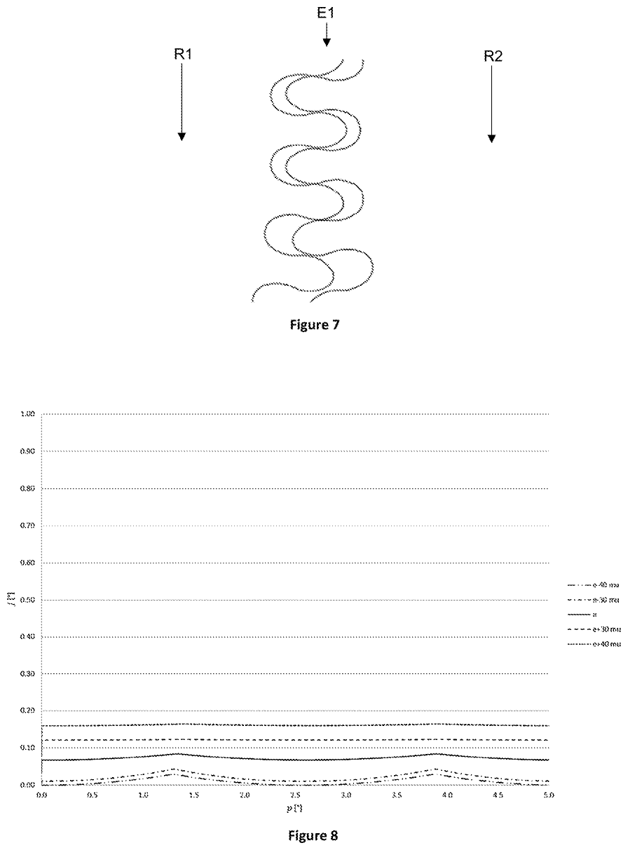

FIGS. 4 to 7 show a first embodiment of the timepiece comprising a first gearing embodiment.

FIG. 8 is a graph representing the variations of the angular backlash of the first embodiment of the gearing over one step and for different axial center distance values.

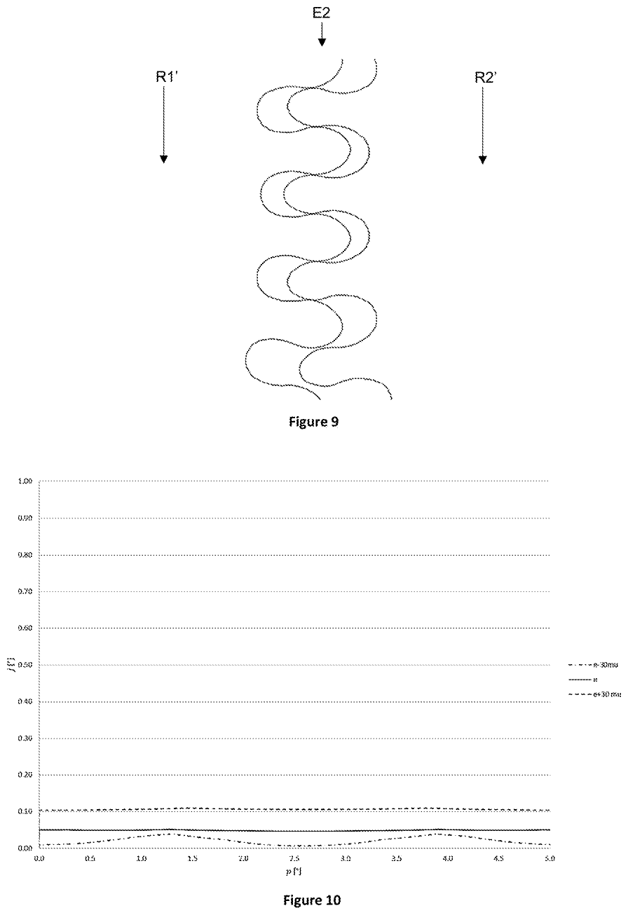

FIG. 9 shows a second embodiment of a gearing used in a second embodiment of the timepiece.

FIG. 10 is a graph representing the variations of the angular backlash of the second embodiment of the gearing over one step and for different axial center distance values.

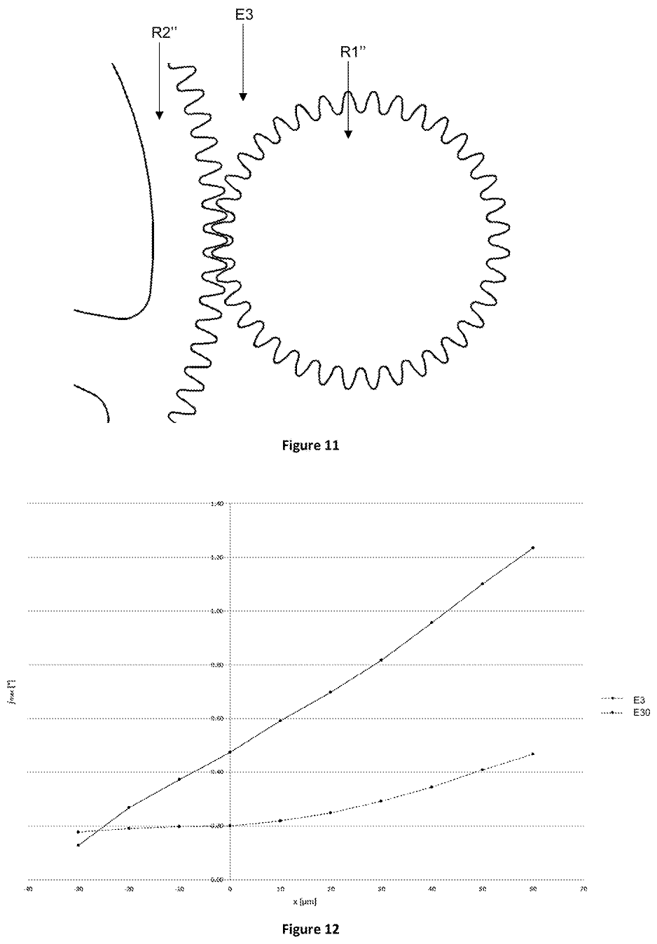

FIG. 11 shows a third embodiment of a gearing used in a second embodiment of the timepiece.

FIG. 12 is a graph representing the variations of the angular backlash of the third embodiment of the gearing over one step and for different axial center distance values.

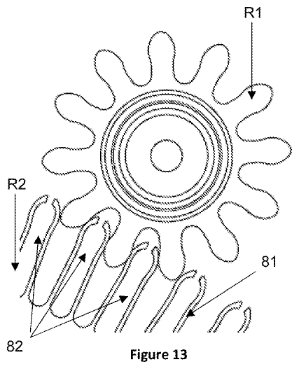

FIG. 13 shows a variant gearing.

A first embodiment of a timepiece 300 is described hereinafter with reference to FIGS. 4 to 8. The timepiece 300 is, for example, a watch, in particular a wristwatch.

The timepiece comprises one embodiment of a horological movement 200. The horological movement may be of the electronic or mechanical, in particular automatic, type.

The horological movement comprises one embodiment of a horological mechanism 100. This mechanism may be a mechanism for displaying time information or information derived from time, or displaying time information or information derived from the time of day, or displaying information of a function that is not time related. In particular, the mechanism may be mechanically linked to the geartrain of the movement, in parallel coupling with that geartrain. For example, the display mechanism may comprise a minute wheel, a chronograph module, a countdown module, a display train of a chronograph module or of a countdown module, or again a display system comprising a rack meshing with a toothed wheel mechanically connected to a display hand. Alternatively, the display mechanism may, for example, comprise a mechanism for displaying information from an altimeter or from a depth meter.

The mechanism 100 comprises first embodiment E1 of the horological gearing.

The gearing E1 comprises a first toothed wheel R1 including symmetrical first teeth dl and a second toothed wheel R2 including symmetrical second teeth d2.

The first toothed wheel is mounted to be mobile in rotation about a first axis A1. The second toothed wheel is mounted to be mobile in rotation about a second axis A2. The first and second toothed wheels are, for example, mounted on a common frame. The first and second axes are preferably parallel or substantially parallel. The axial center distance e between the first and second axes is such that the first and second wheels mesh with one another.

Each of the first and second teeth is conformed and/or arranged so that the primitive backlash [symbol] of the gearing is less than 0.3.m, or even less than 0.25.m, or even less than 0.2.m, or even less than 0.15.m, or even less than 0.1.m, or even less than 0.08.m for a nominal axial center distance e, where m is the modulus of the wheel of which the tooth forms part.

The considerations of the above three paragraphs are preferably equally valid for a second embodiment E2 of a gearing comprising a first toothed wheel R1′ and a second toothed wheel R2′ and for a third embodiment E3 of a gearing comprising a first toothed wheel R1″ and a second toothed wheel R2″. These other two embodiments are referred to later.

In other words, the gearing El has tooth or toothing profiles P1, P2 of a driving wheel and of a driven wheel having the property of minimizing as much as possible the angular backlash during a tooth drive whilst being only very slightly sensitive to axial center distance variations. The properties in terms of efficiency and wear of a gearing of this kind may also advantageously be optimized.

By “angular backlash j” is meant, for a given axial center distance e, the angular movement with which a first wheel R10 can turn freely relative to a second wheel R20 immobilized in a specified orientation, or in a given position. By way of explanatory illustration, FIGS. 1 and 2 show wheels R10 and R20 of this kind of a gearing E0, in which the profiles of the teeth are defined in accordance with the standard NIHS 20-25 known from the prior art. The backlash j is angle α that may be expressed in degrees (or in radians) as represented in FIGS. 1 and 2. In one particular case, the backlash j may in particular be defined as a function of the primitive backlash J.

By “primitive backlash J” is meant, for a nominal axial center distance e, a maximum arc length l along which can travel a point on a primitive circle (Rₚ₂ in FIG. 2) of the first wheel R10 relative to the second wheel R20 immobilized in a specific orientation, as defined by the standard ISO 1122-1:1998. Thus the backlash J is a length that may in particular be expressed in millimeters. The backlash J may also be expressed as a function of the pitch p or of the modulus m of the wheels R10, R20 forming part of the gearing E0.

The angular backlash j can vary as a function of the respective orientations of the first and second wheels R10 and R20. Accordingly, over a tooth drive, the backlash j is caused to evolve. For a give gearing, the greatest angular backlash j is denoted j_{max*} at the nominal axial center distance e of said gearing, the angular backlash jₘₐₓ determined on one or the other of the wheels R10, R20 is expressed as follows:

$${j}_{max} = \frac{{J}_{1 , 2}}{{R}_{P 1 , 2}}$$

with j_{1,2} expressed in radians, and R_{p1,2} the respective primitive radii of the wheels R10, R20.

The backlash j may be defined by one or more pairs of teeth according to the profile chosen for the teeth of each of the wheels forming part of the gearing.

An angular backlash j is necessary for the wheels R10 and R20 to mesh. Nevertheless, too large an angular backlash j risks degrading the quality of the transmission of the movement from the driving wheel to the driven wheel, which could be reflected in vibrations or jerking of the driven wheel.

Moreover, an increase in the axial center distance because of manufacturing and assembly tolerances runs the risk of inducing an increase in the angular backlash j. It is therefore necessary to reduce as much as possible the angular backlash j at the nominal axial center distance of a gearing. However, excessive minimization of the angular backlash j at the nominal axial center distance could induce risks of jamming of the gearing at the minimum axial center distance because of the manufacturing and assembly tolerances.

It proves that conventional horological profiles do not satisfy the definition of gearing in which the wheels have as constant as possible an angular backlash whatever the axial center distance. To be more specific, conventional clock profiles do not satisfy the definition of a gearing in which the wheels have the smallest possible angular backlash that is as constant as possible whatever the axial center distance.

The gearings E1, E2, E3 that are the subject matter of the present document are configured so that the toothing profiles of a driving wheel and of a driven wheel minimize as much as possible the angular backlash during a tooth drive, whilst being only very slightly sensitive to the axial center distance variations induced by industrial manufacturing processes and the means for positioning the means for guiding these wheels, for example for a axial center distance varying over a range [e−20 μm, e+60 μm], e being the nominal axial center distance.

The toothing geometries of the gearings E1, E2, E3 according to the invention typically allow the use of a gearing in which the wheels have a primitive backlash ( [symbol] ) less than 0.3.m, or even less than 0.25.m, or even less than 0.2.m, or even less than 0.15.m, or even less than 0.1.m, or even less than 0.08.m for the nominal axial center distance e, with:

$$m = \frac{2 e}{{z}_{1} + {z}_{2}}$$

where z₁ and z₂ are the respective numbers of teeth of the wheels R1, R1′, R1′″ and R2, R2′, R2″ forming part of the gearing concerned, namely the number of teeth of each of the wheels R1, R1′, R1′″ and R2, R2′, R2″.

By way of example, the horological profile defined in accordance with the standard NIHS 20-25 enables the use of a gearing in which the wheels have a greater primitive backlash.

The geometries of the toothing profiles according to the invention also enable minimization of the variation of the angular backlash as a function of the axial center distance variation.

The modulus m is preferably greater than or equal to 0.05 mm so as to employ a robust gearing able in particular to transmit a predetermined minimum torque.

The tooth or toothing “profile” of a wheel may be defined by the intersection of the tooth or toothing surfaces of the teeth with a plane P perpendicular to the rotation axis of the wheel.

To achieve the aim of minimization of the primitive backlash and minimization of the variation of the angular backlash, the tooth or toothing profiles may have the particular feature of including at least one functional portion PF the shape or the profile of which is a particular circular arc. Based on the work of the applicant, it has been found, in fact, that a gearing with wheels at least one of which has teeth each of which has a functional portion defined by a circular arc of this kind has an angular backlash that can be minimized and rendered substantially constant as a function of the axial center distance of said gearing.

By “functional portion PF” is meant a zone of the profile of a tooth that is conformed to enable minimization of the angular backlash and that is designed to cooperate, at least in part, through contact so as to participate in the meshing of a gearing.

With the aim of simplification of the definition of each of the profiles of the teeth of the wheels R1, R1′, R1″ and R2, R2′, R2″, the wheels R1′, R1″ could more simply be referenced R1 and the wheels R2′, R2″ more simply referenced R2.

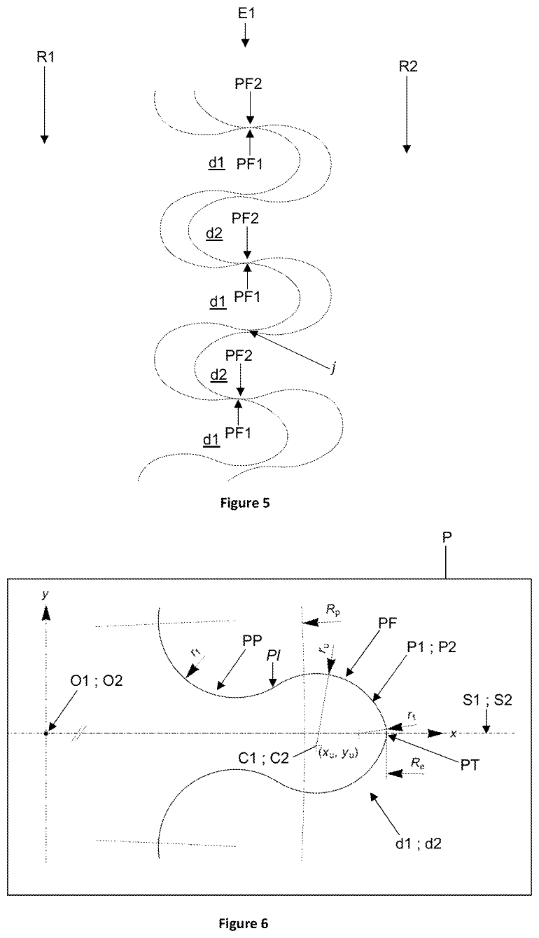

In the embodiment from FIGS. 4 to 7, in the embodiment from FIG. 9 and in the embodiment from FIG. 11, the toothing profiles of the wheels R1 and R2 are preferably defined so that a first functional portion PF1 of the first wheel R1, characterized by a first circular arc, cooperates through contact with a second functional portion PF2 of the second wheel R2, characterized by a second circular arc, as represented in FIG. 5. The first and second functional portions PF1, PF2 can in particular cooperate through contact on the line of the centers passing through the respective centers O₁, O₂, of the wheels R1, R2. The functional portions PF1 and PF2 are preferably characterized by circular arcs having the same radius of curvature rᵤ for a gearing of 1:1 ratio.

The circular arc of radius 7₁, and with center C1, C2 at coordinates (xᵤ,yᵤ) may preferably be determined as follows in a direct orthonormal Cartesian system of axes defined by a triplet (O₁, \vec{e}ₓ,\vec{e}_{y}) or (O₂,\vec{e}ₓ,\vec{e}_{y}), as represented in FIG. 6. O₁ or O₂ coincides with the rotation axis A1 or A2 of the wheel R1 or R2 concerned, the axis A1 or A2 being represented in FIG. 4. \vec{e}ₓ is a unit vector colinear with the axis of symmetry S1, S2 of a tooth d1, d2 having said functional portion PF1 or PF2. \vec{e}_{y} is a unit vector perpendicular to \vec{e}ₓ.

$${r}_{u} = {p}_{i 1} \frac{2 π {R}_{p}}{z}$$

$$an d \text{:}$$

$${x}_{u} = {p}_{i 2} {r}_{u} + {R}_{p}$$

$${y}_{u} = - {p}_{i 3} {r}_{u}$$

with: z, the number of teeth of the wheel R1 or R2 concerned; Rₚ: the primitive radius of the wheel R1 or R2 concerned, with:

$${R}_{p} = \frac{e}{2} ,$$

wnere e is the nominal axial center distance of the gearing of which the wheel R1 or R2 forms part in the case of a gearing with ratio 1:1; pᵢ₂,pᵢ₂,pᵢ₃ are parameters determined on the basis of optimization algorithms so that the primitive backlash [symbol] of the gearing of which the wheel Rᵢ, forms part, namely the wheel R1 or R2, is less than 0.3.m, or even less than 0.25.m, or even less than 0.2.m, or even less than 0.15.m, or even less than 0.1.m, or even less than 0.08.m for a nominal axial center distance e.

The length of the functional portion PF1, PF2 is preferably between m and 4.m inclusive. A functional portion PF1, PF2 of this kind may be associated with at least one other portion such as a tooth head portion PT or a tooth root portion PP so as to define a complete tooth profile. The portions PP, PF, PT preferably define an unbroken continuous function between the various portions. This is reflected in a toothing surface having no edge. The portions PP, PF and PT may all consist of circular arcs tangential to one another.

The tooth head portion PT may advantageously also be defined by a circular arc the radius rₜ of which may be expressed as follows in the Cartesian system of axes (O₁,\vec{e}ₓ,\vec{e}_{y}) or (O₂,\vec{e}ₓ,\vec{e}_{y}):

rₜ=Pᵢ₄(rᵤ+yᵤ)

with pᵢ₄, a parameter determined on the basis of optimization algorithms so that the gearing is able to meet the aforementioned condition, that is to say the primitive backlash [symbol] of the gearing of which the wheel Rᵢ forms part, namely the wheel R1 or R2, is less than 0.3.m, or even less than 0.25.m, or even less than 0.2.m, or even less than 0.15.m, or even less than 0.1.m, or even less than 0.08.m for a given nominal axial center distance e.

The resulting outside or total radius Rₑ of the wheel R1 or R2 may then be expressed in the following manner:

Rₑ=xᵤ+\sqrt{(rᵤ−r₁)²−yᵤ²}+rₜ

The parameters pᵢ₁,pᵢ₂,pᵢ₃,pᵢ₄ are preferably determined on the basis of genetic algorithms that are stochastic optimization algorithms based on the mechanisms of natural selection and genetics. On the basis of a population of initial potential profiles chosen arbitrarily, their relative performance in terms in particular of angular backlash are evaluated. On the basis of this performance, a new population of potential profiles is created using evolutionally operators, namely selection, crossing and mutation. These latter operations are iterated until a satisfactory solution appears.

Accordingly, based on this method, it is possible to determine parameters: (p₁₁,p₁₂,p₁₃,p₁₄), (p₂₁,p₂₂,p₂₃,p₂₄) respectively characterizing portions PF1, PT1, PF2, PT2 of the wheels R1, R2 able to satisfy angular backlash objectives for given axial center distance variation of the wheels R1, R2 and a given number of teeth z1, z2 of the wheels R1, R2.

The tooth root portion PP may be constructed in continuity with the profile. The junction between the portion PF and the portion PP preferably defines an inflection point PI.

In the case of a gearing with ratio 1:1 equipped with wheels R1 and R2 provided with the same number of teeth (z₁=z₂), the respective teeth d1, d2 of the wheels R1 and R2 may be identical or have identical geometries.

In particular, these respective teeth may have functional portions PF1, PF2 that are identical, namely: (p₁₁,p₁₂,p₁₃,p₁₄)≡(p₂₁,p₂₂,p₂₃,p₂₄).

To be more specific, these respective teeth may have portions PF1, PT1, PF2, PT2 that are identical, namely: (p₁₁,p₁₂,p₁₃,p₁₄)≡(p₂₁,p₂₂,p₂₃,p₂₄).

Alternatively, in the case of a gearing with ratio 1:1, the respective teeth of said wheels R1, R2 may be different. In particular, these respective teeth may have different functional portions PF1, PF2. In fact, given that the profile of said teeth is not constructed on the basis of a modulus m, it is possible to define the functional portions PF1, PF2, and to be more specific the portions PF1, PT1, PF2, PT2, best satisfying angular backlash objectives.

Accordingly, in this case: (p₁₁,p₁₂,p₁₃)≢(p₂₁,p₂₂,p₂₃) and, to be more specific: (p₁₁,p₁₂,p₁₃,p₁₄)≢(p₂₁,p₂₂,p₂₃,p₂₄)

The specific parameters (pᵢ₁,pᵢ₂,pᵢ₃, pᵢ₄) may constitute the coordinates of a specific vector \vec{p} satisfying a predefined condition for the primitive backlash [symbol] of a gearing employing a wheel R1 or R2.

The applicant's research moreover shows that it is possible to determine a set of vectors \vec{p} centered on a vector \vec{p}* satisfying a specific condition on the primitive backlash [symbol] of a given gearing.

For example, the set of vectors \vec{p} satisfying the condition: J<0.3.m must satisfy the following condition: (\vec{p}-\vec{p}*)^{t}H(\vec{p}-\vec{p}*)≤1 where H is a covariance type matrix and \vec{p}* a vector with coordinates: (p₁*, p₂*, p₃*, p₄*).

The wheels R1 and R2 may advantageously be rigid. In other words, they preferably do not include an elastic structure enabling compensation of the angular backlash, either on the teeth or on the arms connecting the teeth to the respective hub of the wheels.

Alternatively, whatever the embodiment or the variant, and as represented in FIG. 13, at least one wheel R1, R2 may have at least one elastic structure 81, such that the profiles PF1, PF2 can be defined so as to cancel out the angular backlash over a predefined axial center distance range. The cancellation of the angular backlash over a given axial center distance range enables minimum prestressing of the elastic structure whatever the axial center distance, and therefore minimization of the energy consumed by the gearing.

At the nominal axial center distance e, the at least one elastic structure is preferably not actuated or prestressed. This elastic structure is preferably implemented by cut-outs 82 formed on some or all of the teeth of the wheel R1 and/or of the wheel R2.

The wheels R1, R2 may be produced by machining, in particular by cutting. Alternatively, they may be obtained by micromachining processes such as etching, photolithography or additive manufacturing techniques. These latter techniques have the advantage of very faithfully reproducing the circular arc characterizing the functional portion PF and, more widely, the continuous function characterizing the portions PP, PF and PT. The wheel R1 or R2 may advantageously be made of nickel or a nickel-phosphorus alloy, of silicon, of glass, or of ceramic.

Of course, a first wheel R1 may be obtained by a first method of manufacture while the second wheel R2 may be obtained by a second method of manufacture. Of course, a first wheel R1 may be manufactured in a first material while the second wheel R2 may be manufactured in a second material.

A first wheel R1 or R2 may form part of a geartrain 92 of the horological movement 200. More particularly, a first wheel R1 or R2 may be interleaved, directly or indirectly, between a driving member 91 and a regulating member 93 of the horological movement. Moreover, a second wheel R1 or R2 may be mounted in parallel coupling with said geartrain 92 of the horological movement. By way of example, FIG. 4 more particularly shows a wheel R1 forming part of a geartrain 92 and a wheel R2 mounted in parallel coupling with said geartrain.

The wheel R1 or R2 may be secured to a display member O, in particular a member for displaying a time indication or an indication derived from the time such as a second or a fraction of a second. This display member preferably comprises a hand. Alternatively, the display member may comprise a disk. By “secured to” is preferably meant “fixed to”. However, other mechanical connections may be envisaged. By way of example, FIG. 4 shows the display member O taking the form of a hand that is secured to the wheel R2 mounted in parallel coupling with the geartrain 92.

By way of example, the angular backlash of the gearing E0 consisting of two identical wheels R10, R20 each having 70 teeth defined on the basis of the standard NIHS 20-25 and the modulus m of which is 0.0726 mm, as represented in FIGS. 1 and 2, can in particular be minimized by way of genetic algorithms that enable identification of the parameters characterizing optimized profile portions and modification of the profiles of the teeth.

FIG. 3 shows a graph representing the angular backlash of the gearing E0 over an angular pitch p and for different axial center distances. Note that the maximum angular backlash jₘₐₓ at the nominal axial center distance e is of the order of 0.4°, which corresponds to a primitive backlash J of the order of 0.018 mm, i.e. approximately 0.3.m. Moreover, the angular backlash can vary by a maximum amplitude of the order of 0.65° for a axial center distance varying over a range [e−40 μm, e+40 μm]. In such an example, the sensitivity of the maximum angular backlash as a function of the gearing axial center distance is about 8.3°/mm when considering a gearing axial center distance range of 0.08 mm, the range being centered on the nominal gearing axial center distance (Δjmax/Δe=8.3°/mm).

FIGS. 4 to 7 show the gearing E1 optimized from the point of view of the angular backlash relative to E0 and in which the respective teeth of the wheels R1, R2 are identical, with a profile that is characterized by a vector \vec{p} respecting the following condition:

$${( \vec{p} - {\vec{p}}^{*} )}^{t} H ( \vec{p} - {\vec{p}}^{*} ) \leq 1$$

$$with \text{:}$$

$${\vec{p}}^{*} = ( \begin{matrix}0.30988 \\ 0.16505 \\ 0.17057 \\ 0 .46491\end{matrix} )$$

$$and$$

$$H = ( \begin{matrix}841 & 5.15 & - 427 & 23 \\ & 35.4 & 2.69 & - 12.8 \\ & & 223 & - 17.7 \\ sym . & & & 13.9\end{matrix} )$$

FIG. 8 shows a graph representing the angular backlash [symbol] of the gearing E1 over an angular pitch P and for different axial center distances e, for a given vector \vec{p} respecting the aforementioned condition. Note that the maximum angular backlash jₘₐₓ at the nominal axial center distance e is of the order of 0.08°, i.e. approximately five times less than the backlash jₘₐₓ of the gearing E1 from FIGS. 1 and 2. Accordingly, for this particular vector \vec{p}, [symbol] is of the order of 0.6.m. Moreover, in this particular case, the angular backlash can vary with a maximum amplitude of the order of 0.18° for an axial center distance varying over a range [e−40 μm, e+40 μm], i.e. an angular backlash variation close to four times less than referred to above. In such an example, the sensitivity of the maximum angular backlash as a function of the gearing axial center distance is about 1.7°/mm when considering a gearing axial center distance range of 0.08 mm, the range being centered on the nominal gearing axial center distance (Δjmax/Δe=1.7° /mm).

The exercise has also been carried out for a gearing consisting of two identical wheels R1, R2 each having 60 teeth, with a profile that is characterized by a vector \vec{p} respecting the condition: (\vec{p}-\vec{p}*)^{t}H(\vec{p}-\vec{p}*)≤1

The gains observed are equally surprising, with [symbol] of the order of 0.6 m with a vector \vec{p} giving the best result in terms of minimization of the angular backlash.

In this precise case:

$${\vec{p}}^{*} = ( \begin{matrix}0.30046 \\ 0.20695 \\ 0.14800 \\ 0.64031\end{matrix} )$$

$$H = ( \begin{matrix}3467 & - 204 & - 1282 & - 91 \\ & 96 & 95 & - 12.4 \\ & & 496 & - 49.6 \\ sym . & & & 48.5\end{matrix} )$$

FIG. 9 shows a gearing E2 in accordance with a second embodiment optimized from the point of view of the angular backlash relative to the gearing E0, in which the respective teeth of the wheels R1′, R2′ are different, with the teeth of the wheel R1′ wider than those of the wheel R2′. Thus:

$$\vec{p} = ( \begin{matrix}{p}_{11} \\ {p}_{12} \\ {p}_{13} \\ {p}_{14} \\ {p}_{21} \\ {p}_{22} \\ {p}_{23} \\ {p}_{24}\end{matrix} )$$

$$with \text{:} {( \vec{p} - {\vec{p}}^{*} )}^{t} H ( \vec{p} - {\vec{p}}^{*} ) \leq 1 .$$

In this specific case:

$${\vec{p}}^{*} = ( \begin{matrix}0 .30513 \\ 0.14742 \\ {0}_{.} 19069 \\ 0.56802 \\ 0.30967 \\ 0.14311 \\ ( ) . 21444 \\ 0.56545\end{matrix} )$$

$$H = ( \begin{matrix}317 & 74.1 & - 134 & - 0.771 & 207 & - 73.7 & - 126 & 4.38 \\ & 52.9 & - 26.9 & 0.596 & 17.9 & - 44 & - 17.8 & 1.45 \\ & & 61.8 & - 0.163 & - 94 & 27.1 & 55.3 & - 1.43 \\ & & & 1.06 & - 1.06 & - 0.789 & 0.79 & - 0.194 \\ & & & & 175 & - 23.2 & - 95 & 2.84 \\ & & & & & 41.3 & 20 & - 1.46 \\ & & & & & & 57.6 & - 1.74 \\ sym . & & & & & & & 0.99\end{matrix} )$$

FIG. 10 shows a graph representing the angular backlash of the gearing E2 over an angular pitch P and for different axial center distances [symbol] , for a given vector \vec{p}. Note that the maximum angular backlash jₘₐₓ at the nominal axial center distance is of the order of 0.05°, i.e. approximately eight times less than the maximum angular backlash jₘₐₓ defined by the gearing from FIGS. 1 and 2. Accordingly, [symbol] is of the order of 0.04.m. Moreover, in this particular case, the angular backlash can vary with a maximum amplitude of the order of 0.1° for a axial center distance varying over the range [e−30 μm, e+30 μm]. In such an example, the sensitivity of the maximum angular backlash as a function of the gearing axial center distance is about 1.1°/mm when considering a gearing axial center distance range of 0.06 mm, the range being centered on the nominal gearing axial center distance (Δjmax/Δe=1.1°/mm).

By way of further example, the angular backlash of a gearing E30 that is not shown consisting of a pinion R10″ having 33 teeth defined on the basis of a Treybal profile known from the prior art and the modulus m of which is 0.0602 mm, driving a wheel R20″ having 110 teeth defined on the basis of the Treybal profile and the modulus In of which is 0.0602 mm, can in particular be minimized by means of genetic algorithms. This kind of third embodiment E3 of the gearing is represented in FIG. 11. The profiles of the teeth of the wheels R1″ and R2″ of the gearing E3 according to the third embodiment can be characterized by a vector \vec{p} respecting the condition (\vec{p}-\vec{p}*)^{t}H(\vec{p}-\vec{p}*)≤1, with:

$$\vec{p} = ( \begin{matrix}{p}_{11} \\ {p}_{12} \\ {p}_{13} \\ {p}_{14} \\ {p}_{21} \\ {p}_{22} \\ {p}_{23} \\ {p}_{24}\end{matrix} )$$

$${\vec{p}}^{*} = ( \begin{matrix}0.47511 \\ 0.18843 \\ {0}_{.} 30192 \\ 0.40574 \\ 0.33041 \\ 0.14158 \\ 0.48232 \\ 0.43577\end{matrix} )$$

$$and$$

$$H = ( \begin{matrix}72.2 & 10.1 & - 46.5 & 1.79 & 46.2 & - 2.8 & - 29.6 & 0.459 \\ & 19.9 & - 6.14 & - 0.09 & 2.05 & - 2.49 & - 3.68 & 1.48 \\ & & 34.3 & - 0.97 & - 30.9 & 2.15 & 19.5 & - 0.388 \\ & & & 1.23 & 0.581 & - 1.08 & - 0.656 & - 0.11 \\ & & & & 35.1 & 1.44 & - 19.8 & 0.333 \\ & & & & & 6.26 & 0.711 & 0.321 \\ & & & & & & 14.2 & - 0.154 \\ sym . & & & & & & & 1.09\end{matrix} ) .$$

FIG. 12 represents the maximum angular backlash jₘₐₓ of the gearings E30 and E3 over an angular pitch P in accordance with a variation x of the nominal axial center distance [symbol] of said gearings over a range [e−40 μm, e+60 μm]. In such an example of the gearing E3, the sensitivity of the maximum angular backlash as a function of the gearing axial center distance is about 1.7°/mm when considering a gearing axial center distance range of 0.06 mm, the range being centered on the nominal gearing axial center distance (Δjmax/Δe=1.7°/mm). Note that the maximum angular backlash jₘₐₓ of the gearing E3, at the nominal axial center distance, is of the order of 0.2°, i.e. approximately 2.4 times less than the maximum angular backlash jₘₐₓ defined by the gearing E30. Over the given axial center distance range, the variation of the maximum angular backlash jₘₐₓ of the gearing E3 is moreover of the order of four times less than that induced by the gearing E30. Note furthermore that with a gearing of this kind the variation in the amplitude at the balance wheel is reduced.

The gearings described above therefore have teeth profiles conformed so as to minimize the angular backlash of a horological gearing, in particular of a gearing comprising a wheel mounted in parallel coupling with a geartrain. Moreover, the sensitivity of the variation of the backlash as a function of the gearing axial center distance is limited.

As already seen, the invention concerns a method of manufacturing the gearings E1; E2; E3 and/or the horological mechanism 100 and/or the horological movement 200 and/or the timepiece 300. The method comprises:

a step of determination of the profiles of the first and second toothings of the first wheel R1, R1′, R1″ and of the second wheel R2; R2′; R2″,

a step of shaping the first and second wheels,

a step of mounting the first and second toothed wheels so that they mesh with one another.

The step of determination of the profiles of the first and second toothings of the first wheel R1 and of the second wheel R2 preferably comprises, after a step of selection, in particular a step of arbitrary selection, of profiles of the first and second toothings, iteration of the following steps:

determination of the performance of the profiles of the toothings;

generation of new toothing profiles using genetic algorithms, in particular stochastic optimization algorithms based on mechanisms of natural selection and of genetics and/or algorithms employing evolutionary operators, namely selection and/or crossing and/or mutation.

In this document, by “symmetrical tooth” is meant that there exists a straight line segment passing through the rotation axis of the wheel and constituting an axis of symmetry of the profile of the tooth.

By “toothed wheel” is meant any wheel having a toothing. This definition includes the pinions. This toothing may extend over 360° or over a particular angular range. Accordingly, this definition also includes any rack with a toothed sector. This definition preferably also includes any rack. By “gearing” is meant any assembly comprising toothed wheels of this kind.

By “method of manufacture” of the gearing is meant a method leading to the definition of the profiles of the first and second toothings of the wheels forming part of a gearing of this kind, and shaping or manufacturing each of those wheels.

As previously mentioned, the angular backlash of the gearings according the invention are preferably very slightly sensitive to axial center distance variations. Preferably, in the various embodiments disclosed above or according to the invention, each of the first teeth and of the second teeth is conformed such that the ratio of the variation of maximum angular backlash jmax to the variation of the gearing axial center distance is less than 6°/mm or less than 5°/mm or less than 4°/mm or less than 3°/mm, for a gearing axial center distance value varying between the nominal gearing axial center distance minus 0.04 mm and the nominal gearing axial center distance plus 0.04 mm. Preferably, the upper limits of the ratio mentioned above apply globally to the whole above mentioned range (nominal gearing axial center distance minus 0.04 mm to nominal gearing axial center distance plus 0.04 mm). Preferably, the upper limits of the ratio mentioned above apply locally on the whole above mentioned range (nominal gearing axial center distance minus 0.04 mm to nominal gearing axial center distance plus 0.04 mm) too, i.e. the derivative with respect to the gearing axial center distance of the maximal angular backlash is less than 6°/mm or less than 5°/mm or less than 4°/mm or less than 3°/mm on the whole above mentioned range.

In other words, each of the first teeth and of the second teeth is conformed such that the ratio Δjmax/Δe is less than 6°/mm or less than 5°/mm or less than 4°/mm or less than 3°/mm, Δjmax being the maximal angular backlash of the gearing and Ae being the gearing axial center distance variation and Δe being less or equal to 0.08 mm and Ae being centered on the nominal gearing axial center distance.

Preferably:

the first toothed wheel includes first symmetrical teeth d1, first teeth based on cycloid curves and/or epicycloid curves and/or hypocycloid curves and/or involutes of a circle being excluded, and/or

the second toothed wheel includes second symmetrical teeth d2, second teeth based on cycloid curves and/or epicycloid curves and/or hypocycloid curves and/or involutes of a circle being excluded.

1. A gearing for a horological mechanism, comprising a first toothed wheel including first symmetrical teeth and a second toothed wheel including second symmetrical teeth, each of the first and second teeth being conformed so that the primitive backlash (J) of the gearing is less than 0.3.m, for the nominal axial center distance (e) of the gearing, where m is the modulus of the wheel of which the tooth forms part.

2. The gearing as claimed in claim 1, wherein each of the first teeth and of the second teeth is conformed so that the ratio of the variation of maximum angular backlash (jmax) to the variation of the gearing axial center distance (e) is less than 6°/mm for a gearing axial center distance value varying between the nominal gearing axial center distance minus 0.04 mm and the nominal gearing axial center distance plus 0.04 mm.

3. The gearing as claimed in claim 1, wherein each of the first and second teeth comprises a profile in a plane perpendicular to an axis of the toothed wheel of which the tooth forms part, the profile comprising a functional portion having a shape of a first circular arc, the first circular arc being defined by:
a radius (rᵤ), and
a center (C1; C2) of coordinates (rᵤ,yᵤ) in a direct orthonormal Cartesian system of axes (O₁,\vec{e}ₓ,\vec{e}_{y}; O₂,\vec{e}ₓ,\vec{e}_{y}) centered on the axis of the toothed wheel of which the tooth forms part, \vec{e}ₓ being a unit vector colinear with an axis of symmetry of the tooth, with:
$${r}_{u} = {p}_{i 1} \frac{2 π {R}_{p}}{z} , \\ {x}_{u} = {p}_{ι 2} {r}_{u} + {R}_{p} , \\ {y}_{u} = - {p}_{i 3} {r}_{u}$$
z: number of teeth on the wheel of which the tooth forms part;
Rₚ, primitive radius of the wheel R1 or R2 concerned;
Pᵢ₁,Pᵢ₂,Pᵢ₃: parameters determined so that the primitive backlash (J) of the gearing is less than 0.3 .m for the nominal axial center distance (e) of the gearing, when m is the modulus of the wheel on which the tooth forms part.

4. The gearing as claimed in one of the preceding claims, wherein the profile comprises a tooth head portion having the shape of a second circular arc, the second circular arc being in particular defined by a particular radius (rₜ) as follows;
rₜ=pᵢ₄(rᵤ+yᵤ)
with:
pᵢ₄: a parameter determined so that the primitive backlash (J) of the gearing is less than 0.3.m for the nominal axial center distance (e) of the gearing, when m is the modulus of the wheel on which the tooth forms part.

5. The gearing as claimed in claim 1, wherein the parameters (Pᵢ₁,Pᵢ₂,Pᵢ₃,Pᵢ₄) constitute the coordinates of a first vector (\vec{p}) satisfying the following condition:
(\vec{p}-\vec{p}*)^{t}H(\vec{p}-\vec{p}*)≤1
with:
H: a covariance type matrix, and
\vec{p}*: a vector with coordinates (p₁*,p₂*,p₃*,p₄*).

6. The gearing as claimed in claim 1,
wherein:
the gearing ratio is equal to 1 and/or the first and second wheels have the same number of teeth, and
the teeth of the first and second wheels have the same geometry, or wherein:
the gearing ratio is equal to 1 and/or the first and second wheels have the same number of teeth, and
the teeth of the first and second wheels have different geometries.

7. The gearing as claimed in claim 1, wherein at least one of the following:
at least one selected from the group consisting of the first wheel and the second wheel is secured to a display member;
at least one selected from the group consisting of the first wheel and the second wheel is configured to form part of a geartrain of a horological movement
at least one selected from the group consisting of the first wheel and the second wheel is or are configured to be mounted in parallel coupling with a geartrain of a horological movement.

8. The gearing as claimed in claim 1, wherein the first and second wheels are rigid.

9. The gearing as claimed in claim 1, wherein at least one selected from the group consisting of the first wheel and the second wheel, comprises an elastic angular-backlash-compensation structure, in particular an elastic structure consisting of at least one cut-out in a wheel.

10. The gearing claimed in claim 9, wherein the angular-backlash-compensation elastic structure is not loaded at the nominal axial center distance.

11. A horological mechanism composing a gearing as claimed in claim 10.

12. A horological movements comprising a horological mechanism as claimed in claim 10.

13. A timepiece comprising a horological movement as claimed in claim 12.

14. A method of manufacturing a gearing as claimed in claim 1, wherein the method comprises:
determining the profiles of the first and second toothings of the first wheel and of the second wheel,
shaping the first and second wheels,
mounting the first and second toothed wheels so that they mesh with one another.

15. The method as claimed in claim 15, wherein the determining of the profiles of the first and second toothings of the first wheel and of the second wheel comprises, after selecting profiles of the first and second toothings, iteration of the following:
determining the performance of the profiles of the toothings;
generating new toothing profiles using genetic algorithms.

16. The gearing obtained by the method as claimed in claim 14.

17. The method as claimed in claim 15, wherein the selecting is by arbitrary selection.

18. The method as claimed in claim 17, wherein the generating of new toothing profiles is by using genetic algorithms selected from the group consisting of stochastic optimization algorithms based on mechanisms of natural selection and of genetics, and algorithms employing evolutionary operators by one or several among selection, crossing, mutation.

19. The gearing as claimed in claim 7, wherein at least one selected from the group consisting of the first wheel and the second wheel is configured to be interleaved, directly or indirectly, between a driving member and a member adjusting a horological movement.

20. The gearing as claimed in claim 1, wherein each of the first and second teeth being conformed so that the primitive backlash (J) of the gearing is less than 0.08.m.
